(19) United States
(12) Patent Application Publication
(10) Pub. No.: US 2009/0323529 A1
(43) Pub. Date: Dec. 31, 2009

(54) Apparatus with network traffic scheduler and method

(75) Inventor: Jeremy William Horner, Nottingham, MD (US)

Correspondence Address: ERICSSON INC., 6300 LEGACY DRIVE, M/S EVR 1-C-11, PLANO, TX, 75024, US

(73) Assignee: Ericsson Inc., Warrendale, PA (US)

(21) Appl. No.: 12/215,467

(22) Filed: Jun. 27, 2008

(51) Int. Cl. H04L 12/24; H04L 12/56; H04L 12/28

(52) U.S. Cl. 370/235; 370/412

(57) ABSTRACT

An apparatus for servicing connections in a telecommunications network comprises N ports in communication with the connections through the network. Each port supporting a plurality of virtual links, and each virtual link supporting a plurality of rate groups. The apparatus comprises a processor for providing service to the connections. The apparatus comprises an associative array that stores timestamps of the virtual links and the rate groups. The apparatus comprises a scheduler which chooses which virtual link and rate group is to receive service from the processor as a function of a timestamp. An apparatus for servicing connections in a telecommunications network. The apparatus comprises N ports in communication with the connections through the network. Each port supporting a plurality of virtual links, and each virtual link supporting a plurality of rate groups. The apparatus comprises a processor for providing service to the connections. The apparatus comprises a memory that stores timestamps of the virtual links and the rate groups. The apparatus comprises a scheduler which chooses which virtual link and rate group is to receive service from the processor as a function of a timestamp by searching the timestamps while the timestamps are stored in the memory. A method for servicing connections in a telecommunications network.

### FIELD OF THE INVENTION

The present invention is related to a network traffic scheduler having a memory that stores timestamps of virtual links and rate groups to receive service from a processor as a function of a timestamp. (As used herein, references to the “present invention” or “invention” relate to exemplary embodiments and not necessarily to every embodiment encompassed by the appended claims.) More specifically, the present invention is related to a network traffic scheduler having a memory that stores timestamps of virtual links and rate groups to receive service from a processor as a function of a timestamp where the memory is an associative array and the scheduler chooses which virtual link and rate group is to receive service from the processor as a function of a timestamp by searching the timestamps while the timestamps are stored in the associative array.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

The Role of Network Traffic Schedulers

Network traffic schedulers play a critical role in maximizing network throughput and efficiency while providing Quality of Service guarantees on a per-connection basis. Since each link or connection in a multi-service network can have different performance requirements, the scheduler should store the QoS parameters and track the actual link performance separately for each link. The scheduler should prioritize between the connections providing each with its required bandwidth and should do so in a predictable way in order to minimize traffic loss.

Avoiding Traffic Loss

Traffic Management schemes use traffic policers in order to enforce the Quality of Service guarantees. These policers drop non-conforming traffic so that the offending connection does not use more network resources that it is allotted. The traffic scheduler should be capable of smoothly scheduling the traffic at precise time intervals so that it will be seen as conforming by the traffic policer.

The Hierarchical Traffic Scheduler

The Need for Hierarchical Traffic Scheduling

The deployment of high-speed broadband services such as xDSL and FTTH along with the use of higher speed physical ports on switches and routers means that numerous customers are served by a single high-density physical port on a switch or router. (Ericsson's EDA1200 Broadband Access Node, for example, supports the aggregation of up to 2500 customers.) But, each of these customers expects to be treated as if they are on a single physical port with its associated dedicated bandwidth. And, in order to provide multi-service capabilities (e.g. video, data, and voice) to these customers, the scheduler should be capable of limiting bandwidth to different customers while still providing multiple levels of service to each customer. The hierarchical traffic scheduler is used to provide this capability. FIG. 1 shows how a hierarchical traffic scheduler is structured and FIG. 2 shows where the hierarchical scheduler is placed in the system.

The highest level decision is which physical port to service. The port sequencer (shown in FIG. 2) selects which, if any, port to service and issues scheduling requests to the scheduler at intervals that will match the supported bandwidth of the physical port. The scheduler is then responsible for selecting connections from the appropriate Virtual Link and Rate Group. A Virtual Link is used to rate limit an aggregate of traffic to a total bandwidth, and each Virtual Link can be used to provide a customer with their own dedicated bandwidth just as if they were assigned their own physical port. Each Virtual Link contains another level of rate limiting structures called Rate Groups. Each Rate Group contains one or more connections which share the bandwidth allocated to the Virtual Link. Using multiple Rate Groups for a Virtual Link provides the customer with the multi-service capability with each service assigned its own dedicated bandwidth.

How Smooth Scheduling is Accomplished

Smooth scheduling is accomplished by sending traffic at a specific time interval determined by the programmed transmission rate of the traffic. Using ATM as an example: If a physical port is capable of transmitting 100,000 cells per second, and the transmission rate is set to 1,000 cells per second, the scheduler should schedule one cell every 100^{th} cell time interval. The scheduler uses an internal counter to keep track of time and uses timestamps for the Virtual Links and Rate Groups to maintain their required scheduling interval.

Timestamps

The scheduler uses timestamps to track the scheduling eligibility of each Virtual Link and each Rate Group by storing the next time that it can be scheduled. The timestamp is calculated using the programmed bandwidth and the time that the VL or RG was last scheduled.

Each time that the port sequencer informs the scheduler that a port is eligible to be scheduled, the scheduler examines the timestamps stored for the Virtual Links and Rate Groups belonging to that port and determines if any are eligible to be scheduled during the current time slot. This is done by examining the scheduler's internal time counter and comparing its value to the value stored for the RGs and VLs. If a match is found, then that RG or VL is eligible to be scheduled at the current time slot. The focus of this invention is changing how these timestamps are stored and how they are searched for scheduling eligibility and reaping benefits as a result of those changes.

Current Implementation Techniques

The current approach is to store the timestamp array in a simple SRAM (Synchronous Random Access Memory) which provides storage and retrieval capability, but that is all. The SRAM does not provide any kind of search capability or comparison logic. Therefore, the timestamps cannot be compared in-place. Each time the scheduler searches the timestamps, it should read all of them out of the memory before comparing their values.

How Timestamps are Stored and Accessed

The SRAM used for timestamp storage can be located either internal or external to the FPGA or ASIC. FIG. 3 shows how an SRAM might be organized for timestamp storage for a 4-port scheduler with 2 VLs per port and 2 RGs per VL. Note that in order to access the timestamp stored at a given memory location, the address of that location should be used. FIG. 4 shows how the binary address would be formed with bits 3 and 2 used to select the Port, bit 1 used to select the VL for the Port, and bit 0 used to select the RG for the VL. Together these 4-bits would form the address used as the index to the array of timestamps. That data that is retrieved from the SRAM memory array would include the 32-bit Timestamp indicating when the RG is eligible to transmit and a Valid bit indicating whether that RG is active and eligible to be scheduled. FIG. 5 illustrates how a Time Stamp RAM might be addressed for a 4-port scheduler with 32-VLs per port and 16 RGs per VL.

Process to Search Timestamps

The scheduler searches the timestamps by comparing the 32-bit timestamps (one per VL and one per RG) to find the smallest value. Once the VL and the RG within that VL are selected, the scheduler will choose the next connection in that RG to send. FIG. 6 illustrates the typical process used to compare the 32-bit timestamps used to measure scheduling eligibility. First, the process is followed to determine which VL to schedule. The timestamps for all VLs are sequentially read out of the Time Stamp RAM, and then they go through a multi-stage comparison process to isolate the VL with the smallest timestamp. The process is then repeated to determine which RG in that VL to schedule. The timestamp for all of the RGs in the selected VL are sequentially read out of the Time Stamp RAM and compared using a multi-stage comparison process to isolate the RG with the smallest timestamp.

Example Search of Timestamps for Scheduling Eligibility

FIG. 7 shows an example of an SRAM used to store the timestamps for a 1-port scheduler with 1 VLs per port and 16 RGs per VL. For this example, it is assumed that the present time, which is tracked by the scheduler's internal time counter, has the value 0x00000001 and that the scheduler should locate the RG that is eligible to schedule during that time slot. The scheduler would follow these steps:
1. Perform 16 sequential reads (assuming that one timestamp is stored per memory location) to transfer the timestamps from the 16 memory locations into 2 parallel comparators with 8 timestamps in each comparator.
2. Each comparator locates the most eligible of its 8 timestamps.
3. The two comparators would then have their results compared to determine the most eligible RG for the scheduler to process.
4. The result of that comparison would be eligible for scheduling during the current time slot.

Because numerous reads are required to transfer the memory contents to the comparators and because the timestamp comparison process also requires multiple steps, the scheduler cannot initiate back-to-back timestamp comparisons but should wait for several clock cycles for each one to complete.

Specifications of Hierarchical Schedulers with SRAM Timestamp Storage

Two examples of Ericsson hierarchical schedulers will be mentioned in order to serve as a measure of what is achievable in terms of performance and capability using SRAM for timestamp storage.
A hierarchical scheduler was implemented using an FPGA for a 4-port OC12 Port Card supporting 32 Virtual Links (VL) per port with 16 Rate Groups (RG) per VL for a total of 2048 RGs.
A hierarchical scheduler was implemented using an ASIC for a 4-port OC12 Port Card supporting 32 RGs for each of 32 VLs on each of 4-ports for a total of 4096 RGs.

Problems with Existing Solutions

So far, the above approach has met Ericsson's needs for hierarchical schedulers in our port cards. But, storing the timestamps in SRAM and sequentially reading them out prior to their comparison imposes certain maximum limits on the scheduler. Three limitations will be explored: a maximum number of supported VLs and RGs, the lack of flexibility in the scheduler hierarchy, and scheduler throughput limitations.

Limitation on Number of VLs and RGs Supported

The timestamp values cannot be compared “in-place”, but should instead be read out of RAM and then compared. Each of these steps imposes a limit on the number of timestamps that can be transferred and compared during the required time period. For any given time period, there exists a maximum number of RGs that can exist in a VL and the number of VLs that can exist in a Port while still meeting the performance requirements for the scheduler.

The 4-port OC12 card's scheduler, for example, should complete the above processes every 170 nanoseconds in order to maintain line-rate. But, there are a limited number of RAM reads and a limited number of 32-bit comparisons that can occur in that required time period.

Lack of Flexibility in the Scheduler Hierarchy

Because of these limitations, the VLs and RGs are permanently bound to their port thus preventing the dynamic allocation of the VLs and RGs amongst the ports. (e.g. You cannot create a single port with 64 VLs, and you cannot create a single VL with 64 RGs.) When you consider how Virtual Links are typically used, the negative impact of the fixed hierarchy restriction to the network operator is clearer. Each Virtual Link can be thought of as a virtual port mapped to a single customer with multiple customers sharing the same physical port. Limiting the number of Virtual Links per port to 32 effectively limits the number of customers sharing that physical port to 32. We will examine the benefit to the operator realized because of this invention in Section 0.

Scheduler Throughput Limitations

Another significant drawback to the typical approach is that there are performance limitations due to the number of required steps for each scheduling decision. One of the critical timing paths in the design is the comparison of the 32-bit timestamp values. Timing was successfully met for the 4-port OC12 card using the above approach, but expanding it beyond those requirements in order to achieve a higher line rate would be challenging in an FPGA.

### BRIEF SUMMARY OF THE INVENTION

The present invention pertains to an apparatus for servicing connections in a telecommunications network. The apparatus comprises N ports in communication with the connections through the network. Each port supporting a plurality of virtual links, and each virtual link supporting a plurality of rate groups. The apparatus comprises a processor for providing service to the connections. The apparatus comprises an associative array that stores timestamps of the virtual links and the rate groups. The apparatus comprises a scheduler which chooses which virtual link and rate group is to receive service from the processor as a function of a timestamp.

The present invention pertains to an apparatus for servicing connections in a telecommunications network. The apparatus comprises N ports in communication with the connections through the network. Each port supporting a plurality of virtual links, and each virtual link supporting a plurality of rate groups. The apparatus comprises a processor for providing service to the connections. The apparatus comprises a memory that stores timestamps of the virtual links and the rate groups. The apparatus comprises a scheduler which chooses which virtual link and rate group is to receive service from the processor as a function of a timestamp by searching the timestamps while the timestamps are stored in the memory.

The present invention pertains to a method for servicing connections in a telecommunications network. The method comprises the steps of storing in an associative array timestamps of virtual links and rate groups of N ports in communication with the connections through the network. Each port supporting a plurality of virtual links, and each virtual link supporting a plurality of rate groups. There is the step of choosing with a scheduler which virtual link and rate group stored in the associative array is to receive service from a processor for providing service to the connections as a function of a timestamp.

The present invention pertains to a method for servicing connections in a telecommunications network. The method comprises the steps of storing in a memory timestamps of virtual links and rate groups of N ports in communication with the connections through the network. Each port supporting a plurality of virtual links, and each virtual link supporting a plurality of rate groups. There is the step of choosing with a scheduler which virtual link and rate group stored in the memory is to receive service from a processor for providing service to the connections as a function of a timestamp by searching the timestamps while the timestamps are stored in the memory.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of a hierarchical traffic scheduler.

FIG. 2 shows the direction of operation of the hierarchical scheduler.

FIG. 3 is an SRAM timestamp storage.

FIG. 4 is an example of timestamp SRAM addressing (4-ports, 2 VLs/port, 2 RGs/VL).

FIG. 5 is an example of timestamp SRAM addressing (4-ports, 32 VLs/port, 16 RGs/VL).

FIG. 6 shows a typical prior art approach to choosing a next VL or RG to schedule.

FIG. 7 is an example of SRAM timestamp storage (1-port, 1 VLs/port, 16 RGs/VL).

FIG. 8 is an example of timestamp associative array addressing.

FIG. 9 is an associative array timestamp storage.

FIG. 10 shows choosing a next VL and RG to schedule of the present invention.

FIG. 11 is an example of associative array timestamp storage (4-ports, 2 VLs/port, 2 RGs/VL).

FIG. 12 is a block diagram of the apparatus of the present invention.

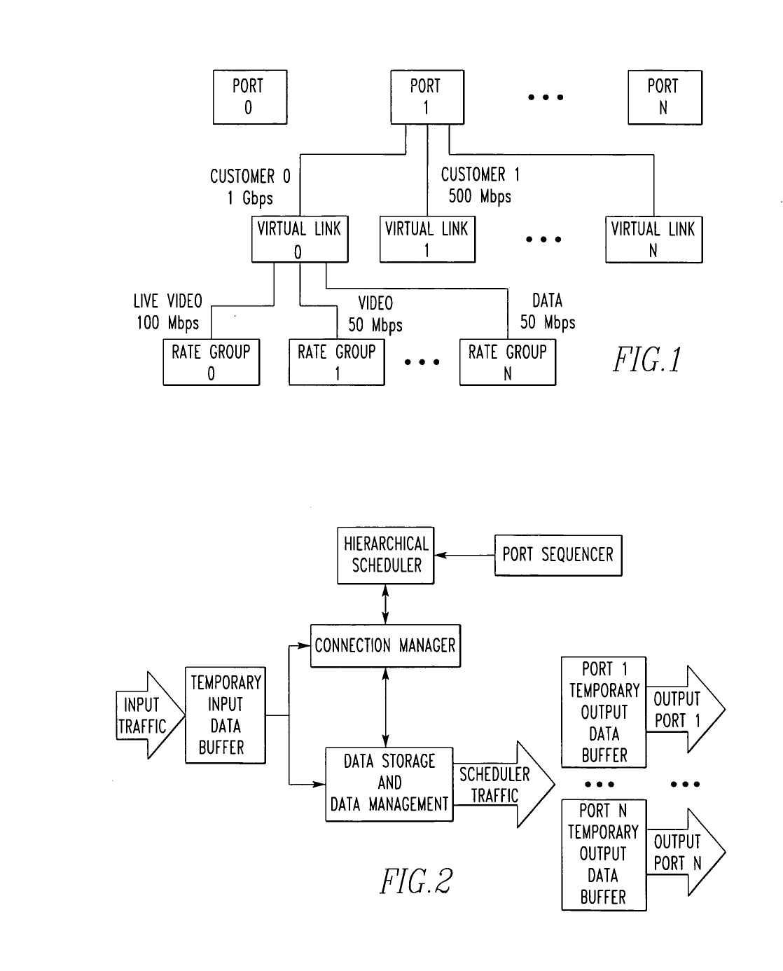

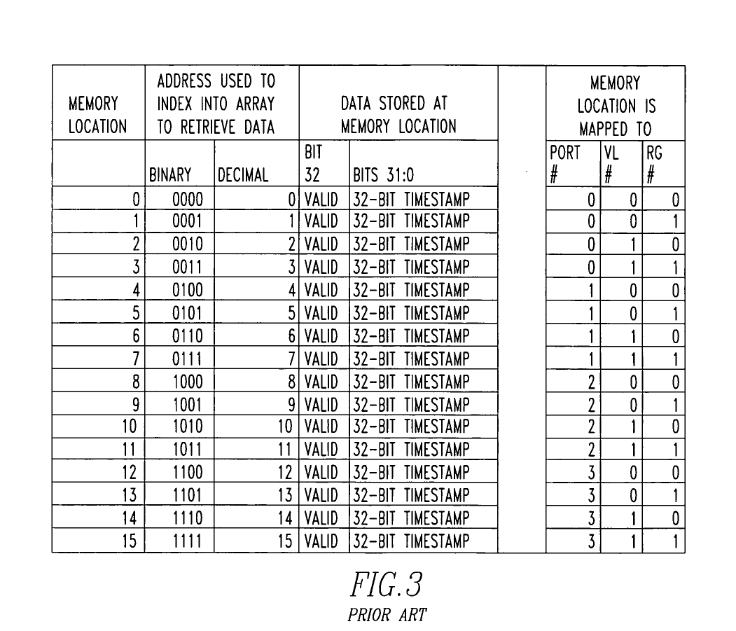

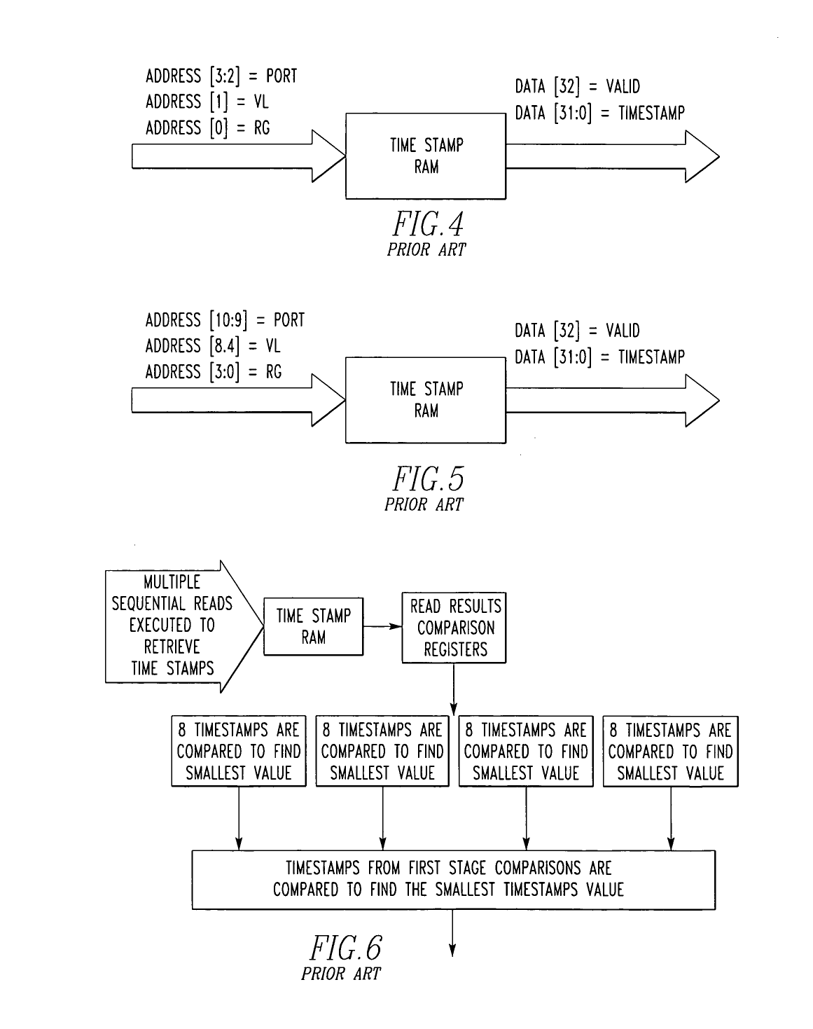

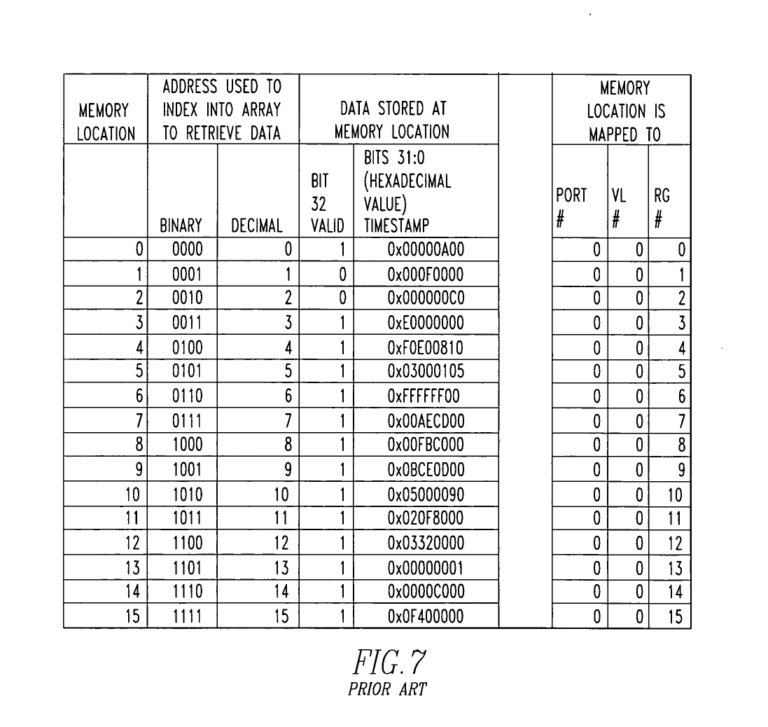

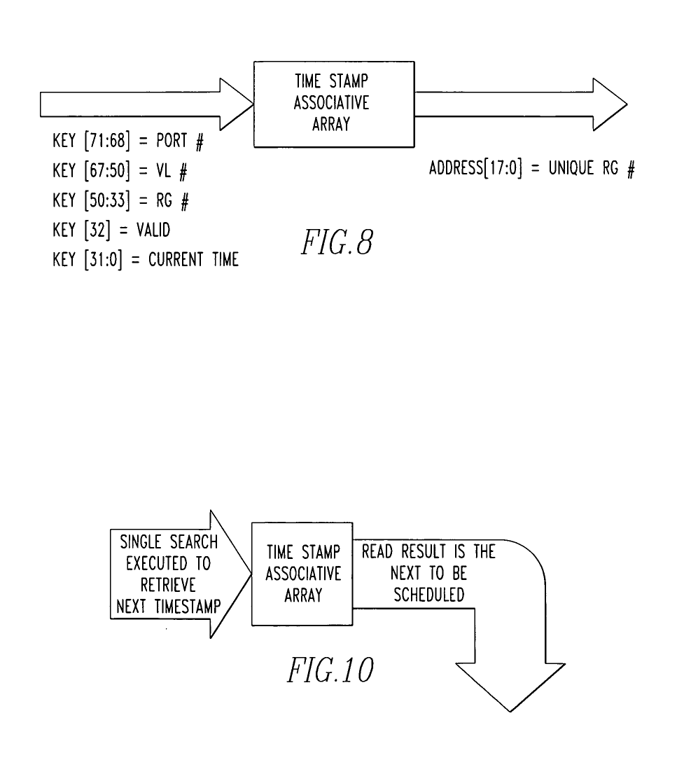

### DETAILED DESCRIPTION OF THE INVENTION

Referring now to the drawings wherein like reference numerals refer to similar or identical parts throughout the several views, and more specifically to FIG. 12 thereof, there is shown an apparatus 10 for servicing connections in a telecommunications network 14. The apparatus 10 comprises N ports 12 in communication with the connections through the network 14. Each port supporting a plurality of virtual links, and each virtual link supporting a plurality of rate groups. The apparatus 10 comprises a processor 16 for providing service to the connections. The apparatus 10 comprises an associative array 18 that stores timestamps of the virtual links and the rate groups. The apparatus 10 comprises a scheduler 20 which chooses which virtual link and rate group is to receive service from the processor 16 as a function of a timestamp.

Preferably, the scheduler 20 determines which rate group in a virtual link is to receive service by using a search key based on the timestamp. The scheduler 20 preferably determines which rate group in a virtual link is to receive service by using a search key based on the timestamp and at least one of a rate group number, a virtual link number and a port number. Preferably, the scheduler 20 uses the search key and searches the timestamps while the timestamps are stored in the array 18 to choose which virtual link and rate group is to receive service.

The scheduler 20 preferably performs only a single search of the array 18 per scheduling session to choose which virtual link and rate group is to receive service. Preferably, the scheduler 20 is a hierarchical scheduler 20. The scheduler 20 preferably updates the virtual link and rate group chosen for service with a new time of eligibility. Preferably, the array 18 is a content addressable memory 22.

The key preferably has up to 576 bits. Preferably, the content adjustable memory 22 stores up to 256 K entries of virtual links and rate groups. The scheduler 20 preferably has a multiple match output flag is raised if multiple rate groups are eligible to be scheduled for a current timeslot. Preferably, the scheduler 20 buffers the multiple rate groups for scheduling. Connections having a given range of bandwidth can be associated with a respective one of the N ports 12. Preferably, the scheduler 20 is an ATM traffic scheduler 20.

The present invention pertains to an apparatus 10 for servicing connections in a telecommunications network 14. The apparatus 10 comprises N ports 12 in communication with the connections through the network 14. Each port supporting a plurality of virtual links, and each virtual link supporting a plurality of rate groups. The apparatus 10 comprises a processor 16 for providing service to the connections. The apparatus 10 comprises a memory 22 that stores timestamps of the virtual links and the rate groups. The apparatus 10 comprises a scheduler 20 which chooses which virtual link and rate group is to receive service from the processor 16 as a function of a timestamp by searching the timestamps while the timestamps are stored in the memory 22.

The present invention pertains to a method for servicing connections in a telecommunications network 14. The method comprises the steps of storing in an associative array 18 timestamps of virtual links and rate groups of N ports 12 in communication with the connections through the network 14. Each port supporting a plurality of virtual links, and each virtual link supporting a plurality of rate groups. There is the step of choosing with a scheduler 20 which virtual link and rate group stored in the associative array 18 is to receive service from a processor 16 for providing service to the connections as a function of a timestamp.

Preferably, the choosing step includes the step of determining which rate group in a virtual link is to receive service by using a search key based on the timestamp. The determining step preferably includes the step of determining which rate group in a virtual link is to receive service by using a search key based on the timestamp and at least one of a rate group number, a virtual link number and a port number. Preferably, the choosing step includes the step of searching the timestamps with the search key while the timestamps are stored in the array 18 to choose which virtual link and rate group is to receive service. There is preferably the step of performing with the scheduler 20 only a single search of the array 18 per scheduling session to choose which virtual link and rate group is to receive service. Preferably, the array 18 is a content addressable memory 22.

The present invention pertains to a method for servicing connections in a telecommunications network 14. The method comprises the steps of storing in a memory 22 timestamps of virtual links and rate groups of N ports 12 in communication with the connections through the network 14. Each port supporting a plurality of virtual links, and each virtual link supporting a plurality of rate groups. There is the step of choosing with a scheduler 20 which virtual link and rate group stored in the memory 22 is to receive service from a processor 16 for providing service to the connections as a function of a timestamp by searching the timestamps while the timestamps are stored in the memory 22.

In the operation of the invention, an associative array 18 is used to store the timestamps instead of SRAM in order to address the above mentioned restrictions and to enhance the capability of the scheduler 20. As stated earlier, an SRAM has no ability to compare or search the timestamps “in-place”. The index of the SRAM memory 22 location with the desired timestamp value is not known until all of the memory 22 locations have been sequentially read and compared against the desired value. But, the associative array 18 provides a key advantage. The desired timestamp can be used as the index (search key) into an associative array 18 such that the memory 22 location is located in a single operation.

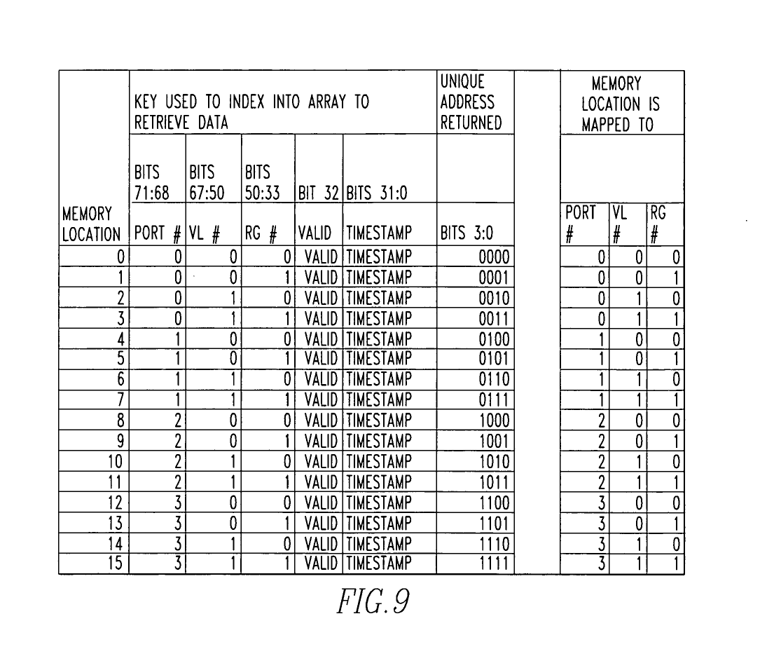

For example, a hierarchical scheduler 20 could be designed using a Content Addressable Memory (CAM), which is a hardware implementation of an associative array 18 that is designed for high speed searches. The port #, VL #, RG #, and 32-bit timestamp could be used as the search key for the CAM entries. Rather than sequentially reading the timestamps out of the SRAM and comparing them according to the process described in FIG. 6, the scheduler 20 would make its decision simply by searching the CAM using the port # and current 32-bit value representing time as the search key. The CAM would then return one or more VLs/RGs that were eligible to schedule at the present cycle. This technique is illustrated in FIG. 9 and in FIG. 10. Using an associative array 18 like this will allow for the timestamp values to be searched “in-place” and at a high rate of speed, bringing several advantages along with it. The approach which is being taken here is to use an associative array 18 in making critical scheduling decisions.

How Timestamps are Stored and Accessed in an Associative Array 18

The associative array 18 is used to store the timestamps which are used to indicate the scheduling eligibility of the VLs and RGs. There would be one entry per RG and it may be necessary to use an additional entry per VL to store the eligibility of the queues that do not belong to the RG. In addition to the timestamp, each key would include the Port # and VL # allowing the scheduler 20 to search for the RG(s) that are eligible for a specific Port or even a specific VL on that port. FIG. 9 shows an example of how an associative array 18 might be used to store timestamps and FIG. 8 shows how it might be indexed with a search key. In this example, the 72-bit key is defined to allow for 256k unique RGs to be dynamically allocated across up to 16-ports. In the extreme case, all 256k RGs could be assigned to a single VL or you could have 256k VLs with a single RG defined for each.

If multiple RGs are eligible to be scheduled for the current time slot, then the associative array 18 will raise its multiple match output flag; this flag is usually included as part of the search response interface. The scheduler 20 could then buffer up those RGs for scheduling, update their time of scheduling eligibility to equal the next time slot, or stop incrementing time by making use of an elastic concept of time. It would be preferable to use the latter approach and use an elastic concept of time so as to minimize the required number of timestamp updates.

It is important to note, however, that when an associative array 18 is used for this purpose, it will be necessary to follow each search that results in a schedule with an update to that RG/VL's entry indicating the new time of eligibility. The associative arrays 18 can operate at a high enough speed that this can be accomplished while still seeing significant performance and flexibility gains.

A specific implementation of an associative array 18 can be chosen based on the requirements for a given design. If a design allows the scheduler 20 a significant amount of time to make each scheduling decision, then it may be possible to use a software implementation of an associative array 18 running on an embedded processor 16. Or, an engineer could choose to implement the associative array 18 using onboard FPGA or ASIC resources. But, if a design requires a high performance scheduler 20, then a dedicated high speed external CAM could be used.

Commercial off-the-shelf (COTS) CAMs are available in a variety of speeds and sizes, and one can be chosen that closely matches the requirements for a given design. CAMs are available that can sustain 250 Million searches per second or higher while storing 256k entries using 72-bits keys. It would be most beneficial to use a ternary CAM which offers the ability to do wild-card searches using a mask and pattern, thus increasing the flexibility of the CAM searches significantly. This would give the scheduler 20 the ability to search for an eligible RG for a given port or a given VL.

FIG. 10 shows the process used to locate a Port, VL, or RG that is eligible to schedule at the current time slot. The scheduler 20 simply indexes into the array 18 by initiating search using the key as the index, and the associative array 18 returns a unique number which corresponds to the Port, VL, and RG that is eligible to be scheduled. Because this can be done in a single operation, search operations could be initiated on consecutive cycles for period of time in order to buffer up scheduling events prior to writing timestamp updates back to the associative array 18. The key point to emphasize here is that the time that the scheduler 20 should wait between the initiations of timestamp searches has been reduced by greater than an order of magnitude.

Using Elastic Time When Multiple Matches are Found

The scheduler should be designed to include the concept of elastic time in order to gracefully recover from receiving multiple matches to a given timestamp search. Even without this recovery mechanism, the scheduler will likely be able to tolerate some number of multiple matches, but when the number of matches exceeds that tolerance level, elastic time should be used in order to recover properly.

It was stated earlier that if a search of the associative array for a specific timestamp results in multiple matches, that the best solution is to have the scheduler read out all of those matches, buffering them up to be sent out during future scheduling slots. It was also stated earlier, that in order for the scheduler to achieve smooth scheduling, that the scheduler maintains an internal clock and that for each increment of that clock, the scheduler will search the associative array seeking any eligible rate groups. But, it is possible that when the time comes for the scheduler to search for eligible RGs at this new time, that it is still reading out and buffering multiple matches from the previous search. It is not possible to initiate a new search with the new time until all of the previous matches were read out and buffered. It is this type of scenario where elastic time is needed.

Elastic time uses two internal clocks, one is used to track the ideal time and one is used to track the current operational time. If the time has come for the clock to be incremented, but the search results are still being read out, then the ideal time will still be incremented while the current operational time will remain unchanged until the search results have been read. Once they have been read, the operational time will start accelerating in order to catch up to the ideal time. Time is described as elastic because the operating time can slow down or speed up as necessary relative to the ideal time in order to finish required operations.

Implementing the Elastic Time Recovery Mechanism

Elastic Time could be implemented in one of two ways. Table 1 shows an example of a basic Elastic Time recovery mechanism which takes advantage of the fact that, in this example, a new timestamp search can be initiated every clock cycle, but “time” only increments every 3^{rd} clock cycle. The scheduler can tolerate up to three matches to a given search without initiating the recovery mechanism. If the number of matches is greater than the time period (measured in # of clock cycles), then the Operational Time starts to fall behind the Ideal Time. When a given search results in fewer than three matches (in this example), Operational Time can speed up by issuing a new search each available clock cycle until it equals Ideal Time once again. Note that using this basic approach to Elastic Time Recovery results in the Operational Time falling behind the Ideal Time at clock cycle 9 and equaling the Ideal Time at clock cycle 23.

TABLE 1
Example of Basic Elastic Time Recovery Mechanism
Ideal Time period 3

| | | | | # of Matches | ELASTIC | |
|---|---|---|---|---|---|---|
| Clock | Ideal | Operational | Timestamp | Remaining | Time | |
| Cycle | Time | Time | Search | to Read | Difference | Comments |
| 0 | 0 | 0 | 0 | 1 | | single search result which is read |
| 1 | 0 | 0 | | 0 | | out long before the ideal time |
| 2 | 0 | 0 | | 0 | | increments |
| 3 | 1 | 1 | 1 | 3 | | multiple search results, but there is |
| 4 | 1 | 1 | | 2 | | still time to read them all out before |
| 5 | 1 | 1 | | 1 | | the ideal time increments |
| 6 | 2 | 2 | 2 | 10 | | |
| 7 | 2 | 2 | | 9 | | |
| 8 | 2 | 2 | | 8 | | |
| 9 | 3 | 2 | | 7 | 1 | Ideal time increments, but results |
| 10 | 3 | 2 | | 6 | 1 | are still being read resulting in time |
| 11 | 3 | 2 | | 5 | 1 | becoming elastic. The Operational |
| | | | | | | Time falls behind the Ideal Time by |
| | | | | | | 1 clock tick. |
| 12 | 4 | 2 | | 4 | 2 | Operational Time falls further |
| 13 | 4 | 2 | | 3 | 2 | behind because results are still |
| 14 | 4 | 2 | | 2 | 2 | being read |
| 15 | 5 | 2 | | 1 | 3 | Operational Time falls further |
| | | | | | | behind because results are still |
| | | | | | | being read |
| 16 | 5 | 3 | 3 | 0 | 2 | Now that the results have all been |
| | | | | | | read, time can begin to speed up |
| | | | | | | again to catch up to the ideal time. |
| | | | | | | NOTE: This lookup was wasted |
| | | | | | | since it did not return a match. |
| 17 | 5 | 4 | 4 | 0 | 1 | Continue to increment Operational |
| | | | | | | Time in order to catch up, and again |
| | | | | | | this lookup was wasted with no |
| | | | | | | match returned. |
| 18 | 6 | 5 | 5 | 4 | 1 | Multiple matches were received and |
| 19 | 6 | 5 | | 3 | 1 | were not able to increment |
| 20 | 6 | 5 | | 2 | 1 | Operational Time as the Ideal Time |
| | | | | | | incremented. |

Example Search of Timestamps for Scheduling Eligibility in an Associative Array

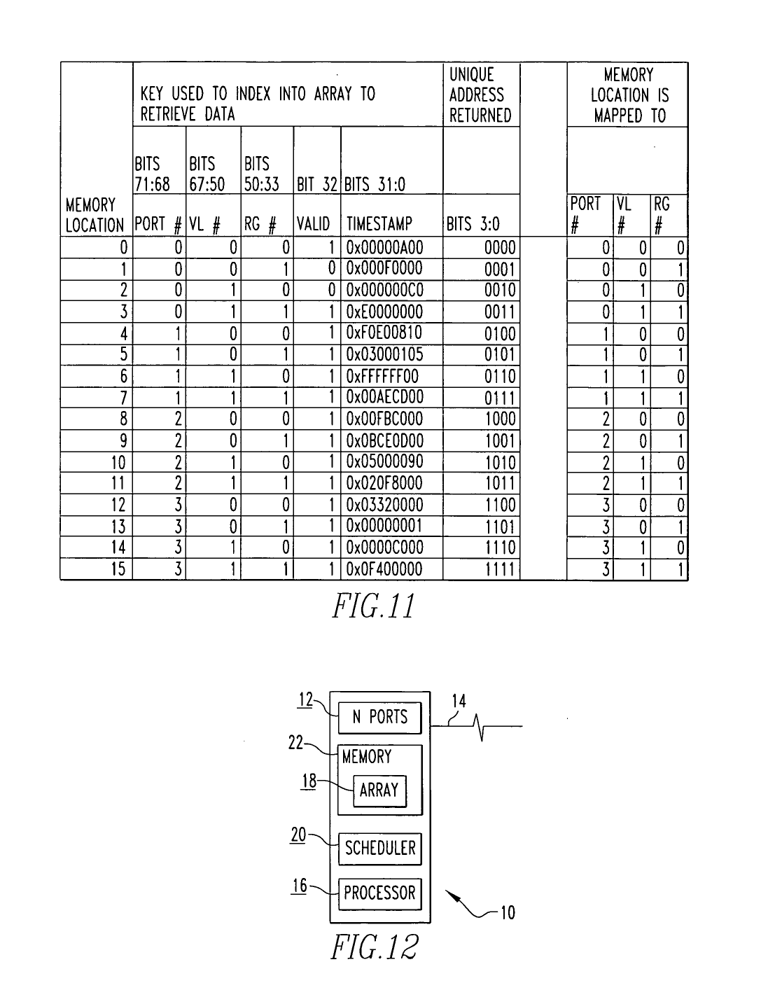

FIG. 11 shows an example of an associative array 18 used for timestamp storage for a 4-port scheduler 20 with two VLs per port and two RGs per VL. For this example, assume that the present time, which is tracked by the scheduler's internal time counter, has the value 0x00000001 and that the scheduler 20 should locate the RG that is eligible to schedule during that time slot for Port 3. The scheduler 20 would follow these steps:
1. The scheduler 20 would initiate a search in the associative array 18 with the following search key:

| Bits 71:68 | Bits 67:50 | Bits 50:33 | Bit 32 | Bits 31:0 |
|---|---|---|---|---|
| Port # | VL # | RG # | Valid | Timestamp |
| 3 | don't care | don't care | 1 | 0x00000001 |

2. The associative array 18 would return the binary value 1101 which would map to Port 3, VL 0, and RG 1. This RG would therefore be eligible for scheduling during the current time slot.

The advantages of this invention include an increase in the number of VLs/RGs supported, a more flexible scheduler 20 hierarchy, and higher performance.

Increased Number of VLs/RGs and a More Flexible Hierarchy

Because the search performance of an associative array 18 is not impacted by the number of entries, it is possible to increase the number of VLs and RGs that are supported and dynamically allocate them within the hierarchy so that a large number (or all of them) are assigned to a single port or VL. As an example of the increased capability that is possible using this approach: An Ericsson-designed scheduler with SRAM-based Timestamp storage was previously mentioned that supports a total of 4096 RGs evenly divided among its ports and VLs. CAMs are readily available which support 256k (262144) entries making it possible to support 64 times the total number of RGs that were supported in that scheduler or 128 times the total number of RGs supported in the other scheduler mentioned above. And, there would be no restriction on where in the hierarchy they would be placed.

The above example, “Lack of flexibility in the Scheduler Hierarchy” is revisited. Using an associative array 18 in the scheduler 20 to remove this restriction allows the operator to optimize the scheduler 20 hierarchy based on the number of customers and the bandwidth consumed by each customer. A large number of customers with low bandwidth requirements could all share one physical port while a smaller number of customers with high bandwidth requirements could share another physical port. The scheduler's Virtual Links and Rate Groups would be used where they are needed and not wasted where they are not required. This type of flexibility could be especially useful for Ericsson multi-service platforms that offer a wide-range of interface speeds.

Increased Performance

Using an associative array 18 for identifying any VLs/RGs which are eligible to be scheduled at the current time rather than using traditional methods will remove that comparison from the critical path. It will improve the performance of these comparisons by an order of magnitude or more which should allow one to achieve hierarchical scheduling at OC192 rates, or possibly even higher.

It should also be noted that although the example given here was for an ATM traffic scheduler 20, associative arrays 18 could be used for other types of traffic scheduler 20s as well.

### ABBREVIATIONS

CAM=Content Addressable Memory.
COTS=Commercial Off The Shelf
RG=Rate Group
SRAM=Synchronous Random Access Memory
VL=Virtual Link

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An apparatus for servicing connections in a telecommunications network comprising:
N ports in communication with the connections through the network, each port supporting a plurality of virtual links, and each virtual link supporting a plurality of rate groups;
a processor for providing service to the connections;
an associative array that stores timestamps of the virtual links and the rate groups; and
a scheduler which chooses which virtual link and rate group is to receive service from the processor as a function of a timestamp.

2. An apparatus as described in claim 1 wherein the scheduler determines which rate group in a virtual link is to receive service by using a search key based on the timestamp.

3. An apparatus as described in claim 2 wherein the scheduler determines which rate group in a virtual link is to receive service by using a search key based on the timestamp and at least one of a rate group number, a virtual link number and a port number.

4. An apparatus as described in claim 3 wherein the scheduler uses the search key and searches the timestamps while the timestamps are stored in the array to choose which virtual link and rate group is to receive service.

5. An apparatus as described in claim 4 wherein the scheduler performs only a single search of the array per scheduling decision to choose which virtual link and rate group is to receive service.

6. An apparatus as described in claim 5 wherein the scheduler is a hierarchical scheduler.

7. An apparatus as described in claim 6 wherein the scheduler updates the virtual link and rate group chosen for service with a new time of eligibility.

8. An apparatus as described in claim 7 wherein the array is a content addressable memory.

9. An apparatus as described in claim 8 wherein the key has up to 576 bits.

10. An apparatus as described in claim 9 wherein the content adjustable memory stores up to 256 K entries of virtual links and rate groups.

11. An apparatus as described in claim 10 wherein the scheduler has a multiple match output flag is raised if multiple rate groups are eligible to be scheduled for a current timeslot.

12. An apparatus as described in claim 11 wherein the scheduler buffers the multiple rate groups for scheduling.

13. An apparatus as described in claim 12 wherein the scheduler uses elastic time in regard to service concerning the multiple rate groups.

14. An apparatus as described in claim 13 wherein connections having a given range of bandwidth are associated with a respective one of the N ports.

15. An apparatus as described in claim 14 wherein the scheduler is an ATM traffic scheduler.

16. An apparatus for servicing connections in a telecommunications network comprising:
N ports in communication with the connections through the network, each port supporting a plurality of virtual links, and each virtual link supporting a plurality of rate groups;
a processor for providing service to the connections;
a memory that stores timestamps of the virtual links and the rate groups; and
a scheduler which chooses which virtual link and rate group is to receive service from the processor as a function of a timestamp by searching the timestamps while the timestamps are stored in the memory.

17. A method for servicing connections in a telecommunications network comprising the steps of:
storing in an associative array timestamps of virtual links and rate groups of N ports in communication with the connections through the network, each port supporting a plurality of virtual links, and each virtual link supporting a plurality of rate groups; and
choosing with a scheduler which virtual link and rate group stored in the associative array is to receive service from a processor for providing service to the connections as a function of a timestamp.

18. A method as described in claim 17 wherein the choosing step includes the step of determining which rate group in a virtual link is to receive service by using a search key based on the timestamp.

19. A method as described in claim 18 wherein the determining step includes the step of determining which rate group in a virtual link is to receive service by using a search key based on the timestamp and at least one of a rate group number, a virtual link number and a port number.

20. A method as described in claim 19 wherein the choosing step includes the step of searching the timestamps with the search key while the timestamps are stored in the array to choose which virtual link and rate group is to receive service.

21. A method as described in claim 20 including the step of performing with the scheduler only a single search of the array per scheduling decision to choose which virtual link and rate group is to receive service.

22. A method as described in claim 21 wherein the array is a content addressable memory.

23. A method for servicing connections in a telecommunications network comprising the steps of:
storing in a memory timestamps of virtual links and rate groups of N ports in communication with the connections through the network, each port supporting a plurality of virtual links, and each virtual link supporting a plurality of rate groups; and
choosing with a scheduler which virtual link and rate group stored in the memory is to receive service from a processor for providing service to the connections as a function of a timestamp by searching the timestamps while the timestamps are stored in the memory.
